(19) United States
(12) Patent Application Publication
(10) Pub. No.: US 2012/0213419 A1
(43) Pub. Date: Aug. 23, 2012

(54) PATTERN RECOGNITION METHOD AND APPARATUS USING LOCAL BINARY PATTERN CODES, AND RECORDING MEDIUM THEREOF

(75) Inventors: Dai Jin KIM, Pohang-city (KR); Tae Wan Kim, Busan-city (KR)

(73) Assignee: POSTECH ACADEMY-INDUSTRY FOUNDATION, Pohang-si (KR)

(21) Appl. No.: 13/032,189

(22) Filed: Feb. 22, 2011

(51) Int. Cl. G06K 9/00

(52) U.S. Cl. 382/118

(57) ABSTRACT

A pattern recognition method using Maximization of Mutual Information (MMI)-based Local Binary Pattern (LBP) codes transforms training face images into LBPs and generates LBP-transformed feature vectors based on positions of image pixels. Thereafter, a dimension of each image is reduced by selecting feature vectors maximizing mutual information with a class label vector from among N feature vectors, 256 LBP frequency feature vectors are obtained by performing an LBP code-based histogram transform per image, and Optimal LBP (OLBP) codes maximizing mutual information with the class label vector for the 256 LBP frequency feature vectors are selected. These selected OLBP codes are codes guaranteeing minimization of a classification error rate, and by applying the selected OLBP codes to pattern recognition, a better recognition performance than a conventional local kernel-based image representation method and an enhanced recognition speed due to a reduced number of LBP codes are provided.

### BACKGROUND OF THE INVENTION

1. Field of the Invention

The present invention generally relates to a pattern recognition method and apparatus, and more particularly, to a pattern recognition method and apparatus using Maximization of Mutual Information (MMI)-based Local Binary Pattern (LBP) codes to increase recognition speed and recognition performance by using a small number of pattern codes having an excellent classification performance in pattern recognition using template matching based on a local kernel, and a recording medium thereof.

2. Description of the Related Art

Many less informative codes exist in codes used in a conventional local kernel-based image representation method for face recognition. These less informative codes decrease recognition performance, and since a pattern is represented with a high-dimensional vector in pattern matching due to a great number of codes, a lot of time is necessary for recognition.

For example, a patent document (Patent Registration No. 0723406) of a face verification method and apparatus using a conventionally publicized Local Binary Pattern (LBP) discrimination method and a patent document (Patent Registration No. 0866792) of a face descriptor generation method and apparatus using extended LBPs and a face recognition method and apparatus using the same disclose a method of performing face recognition and verification using LBPs. However, since conventional recognition methods use all 256 patterns including less discriminative codes, the conventional recognition methods affect recognition performance. That is, if these unnecessary codes are used, a recognition speed in pattern matching is decreased.

### SUMMARY OF THE INVENTION

The present invention provides a pattern recognition method and apparatus using Maximization of Mutual Information (MMI)-based Local Binary Pattern (LBP) codes to increase recognition performance and a recognition speed by representing an image using only a few better discriminative codes between classes from among 256 LBPs in a low-spec portable terminal and robot environment.

According to an aspect of the present invention, there is provided a pattern recognition method using MMI-based LBP codes, the pattern recognition method including: a) transforming D training face images into LBPs and generating dimensionality-reduced training face images with M feature vectors selected using a preset class label vector from among N feature vectors generated for each of the LBP-transformed training face images; b) calculating 256 frequency feature vectors, each indicating a presence frequency of a corresponding LBP code, for each of the dimensionality-reduced training face images; c) selecting K Optimal LBP (OLBP) codes maximizing mutual information with the class label vector for the 256 frequency feature vectors; d) enrolling a face image by LBP-transforming the face image to be enrolled using the selected OLBP codes and generating a template feature vector; and e) recognizing a face of an input face image by using the selected OLBP codes and the template feature vector calculated in the enrollment of the face image.

In operation a), the N feature vectors may be N (the number of horizontal pixels×the number of vertical pixels) D-dimensional feature vectors based on positions of pixels of each of the LBP-transformed training face images.

In operation a), the M selected feature vectors may be feature vectors maximizing mutual information with the preset class label vector among the N LBP-transformed feature vectors.

The selection of the M feature vectors may be computed by the equation below

$${argmax}_{{f}_{t} ∈ {F}_{LBP}} [ I ( C ; {f}_{i} ) - \frac{1}{\vert {S}_{LBP} \vert} {\sum }_{{f}_{j} ∈ {S}_{LBP}} I ( {f}_{i} ; {f}_{j} ) ] ,$$

where I(C;fᵢ) denotes an amount of mutual information between a feature vector and the class label vector, C denotes the class label vector, F_{LBP} denotes a set of the N feature vectors, fᵢ denotes an i^{th} feature vector, and S_{LBP} denotes a set of selected feature vectors.

In operation b), the calculation of the 256 frequency feature vectors may include: b1) generating an LBP code-based histogram vector for each of the dimensionality-reduced training face images; b2) generating 256 LBP frequency feature vectors, each indicating a presence frequency of a corresponding LBP vector, from the histogram vector; and b3) selecting K frequency feature vectors maximizing mutual information with the preset class label vector among the 256 frequency feature vectors.

In operation b3), the selection of the K frequency feature vectors may be computed by the equation below

$${argmax}_{{l}_{i} ∈ {F}_{CODE}} [ I ( C ; {l}_{i} ) - \frac{1}{\vert {S}_{CODE} \vert} {\sum }_{{l}_{j} ∈ {S}_{CODE}} I ( {l}_{i} ; {l}_{j} ) ]$$

where I(C;Iᵢ) denotes an amount of mutual information between a frequency feature vector and the class label vector, C denotes the class label vector, F_{CODE} denotes a set of the 256 LBP frequency feature vectors, Iᵢ denotes an i^{th} frequency feature vector, and S_{CODE} denotes a set of selected frequency feature vectors.

In operation d), the generation of the template feature vector may include: d1) dividing the enrollment face image represented using the K LBP codes into ra×rb region units; and d2) generating an ra×rb×K-dimensional template feature vector by calculating K OLBP-based histograms for each region in the divided enrollment face image and sequentially concatenating the histograms independently calculated for the ra×rb regions.

Operation e) may include: e1) dividing the input face image into ra×rb regions using the K OLBP codes; e2) calculating an ra×rb×K-dimensional input feature vector by calculating K OLBP-based histograms for each region in the divided input face image and sequentially concatenating the histograms independently calculated for the ra×rb regions; and e3) recognizing an input face based on a distance value between relative templates for each enrollment face image and the input face image by using the K OLBP codes.

According to another aspect of the present invention, there is provided a pattern recognition apparatus using MM I-based LBP codes, the pattern recognition apparatus including: a means for transforming D training face images into LBPs and generating dimensionality-reduced training face images with M feature vectors selected using a preset class label vector from among N feature vectors generated for each of the LBP-transformed training face images; a means for calculating 256 frequency feature vectors, each indicating a presence frequency of a corresponding LBP code, for each of the dimensionality-reduced training face images; a means for selecting K Optimal LBP (OLBP) codes maximizing mutual information with the class label vector for the 256 frequency feature vectors; a means for enrolling a face image by LBP-transforming the face image to be enrolled using the selected OLBP codes and generating a template feature vector; and a means for recognizing a face of an input face image by using the selected OLBP codes and the template feature vector calculated in the enrollment of the face image.

According to an embodiment of the present invention, since an MMI based LBP code selection method guarantees minimization of a classification error rate by selecting a few codes maximizing mutual information between LBP codes and a class label vector, the MMI based LBP code selection method provides an enhanced recognition speed due to a better recognition performance and a less number of codes than conventional local kernel-based image representation methods such as original LBP and Modified Census Transform (MCT).

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart of a training stage showing a method of selecting Local Binary Pattern (LBP) codes-based on the Maximization of Mutual Information (MMI), according to an exemplary embodiment of the present invention;

FIG. 2 is a diagram for describing a method of generating LBP-transformed feature vectors through D training images;

FIGS. 3A and 3B are images showing training face images used in recognition and sets of indices according to the numbers of feature vectors obtained from face images;

FIG. 4 is a diagram showing a process of performing an LBP code-based histogram transform per image for dimensionality-reduced training face images;

FIGS. 5A to 5D show 4 expression (angry, surprised, pleasant, and expressionless) images among training images for expression recognition and images represented with respect to the numbers of OLBP codes selected from these 4 expression images;

FIG. 6 is a flowchart of a method of applying K selected OLBP codes to a face recognition system, according to an exemplary embodiment of the present invention; and

FIG. 7 shows an image obtained by dividing a face image into 5×5 regions.

### DETAILED DESCRIPTION OF THE INVENTION

The present invention will now be described more fully with reference to the accompanying drawings, in which exemplary embodiments of the invention are shown.

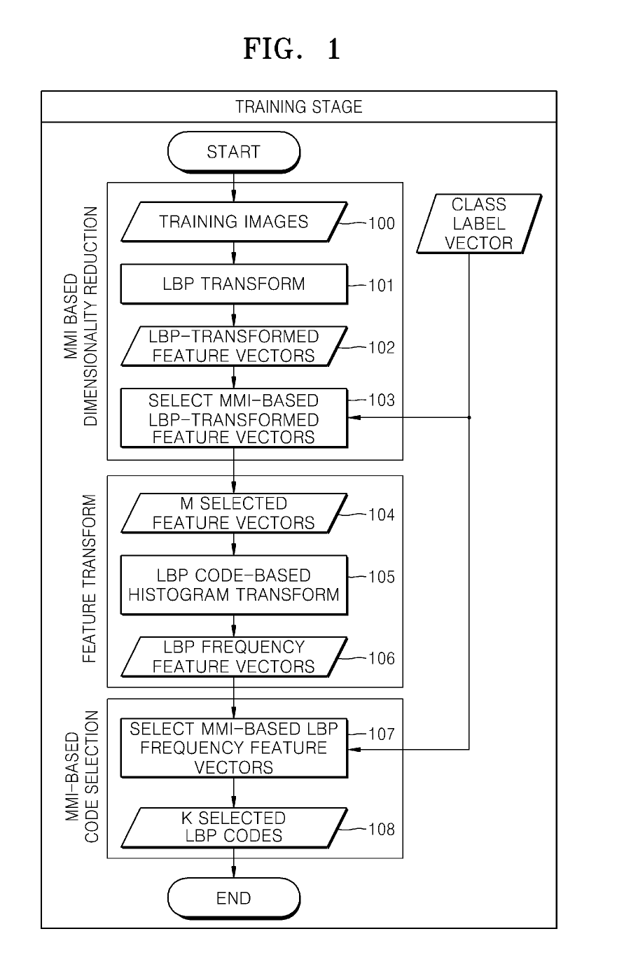

FIG. 1 is a flowchart of a training stage showing a method of selecting Local Binary Pattern (LBP) codes based on the Maximization of Mutual Information (MMI), according to an exemplary embodiment of the present invention.

In operations 100 to 102, N (the number w of horizontal pixels of an image×the number h of vertical pixels of the image) D-dimensional feature vectors are obtained by LBP-transforming D training face images and performing vectorization of the D LBP-transformed training face images.

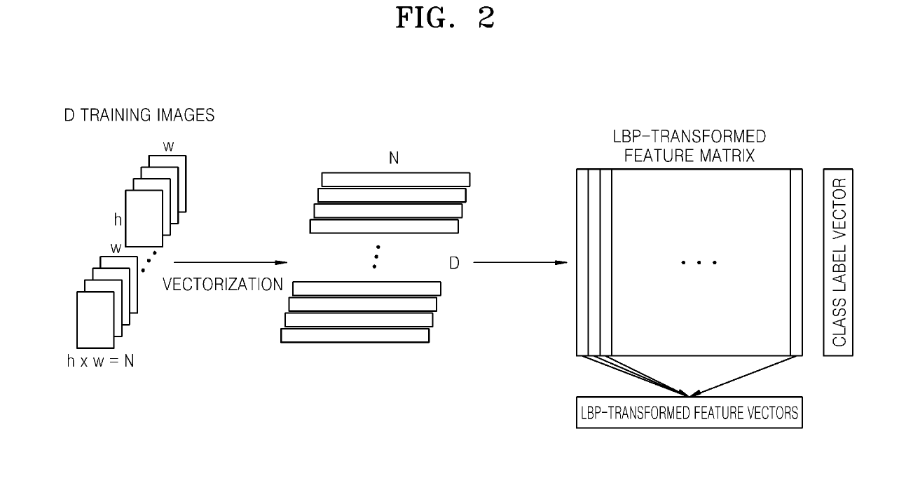

FIG. 2 shows a process of obtaining N×D-dimensional feature matrices for the D 2-dimensional training images. Column vectors of the LBP-transformed feature vectors are the obtained feature vectors.

In operation 103, M feature vectors maximizing mutual information between the LBP-transformed feature vectors and a class label vector preset for a face image are calculated by Equation 1.

$${argmax}_{{f}_{i} ∈ {F}_{LBP}} [ I ( C ; {f}_{i} ) - \frac{1}{\vert {S}_{LBP} \vert} {\sum }_{{f}_{j} ∈ {S}_{LBP}} I ( {f}_{i} ; {f}_{j} ) ] \qquad ( 1 )$$

Here, I(C;fᵢ) denotes an amount of mutual information between a feature vector and the class label vector, C denotes the class label vector, F_{LBP} denotes a set of the N feature vectors, fᵢ denotes an i^{th} feature vector, and S_{LBP} denotes a set of selected feature vectors. A set of indices corresponding to the M feature vectors indicate positions of pixels having the best distinguishability for training images.

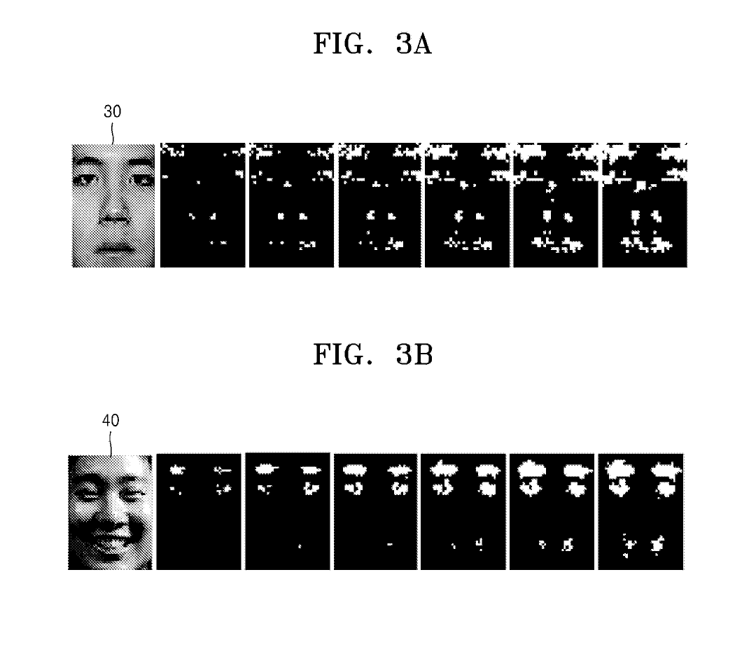

FIGS. 3A and 3B are images showing results representing sets of indices corresponding to 40, 80, 120, 160, 200, and 240 feature vectors obtained in a right direction from Equation 1 using training face images 30 and 40. Here, white pixels indicate positions of pixels corresponding to feature vectors selected by Equation 1, and black pixels indicate unselected pixels.

In operations 104 to 106, 256 LBP frequency feature vectors are calculated by performing an LBP code-based histogram transform of each face image for the dimensionality-reduced training face images, each including M feature vectors.

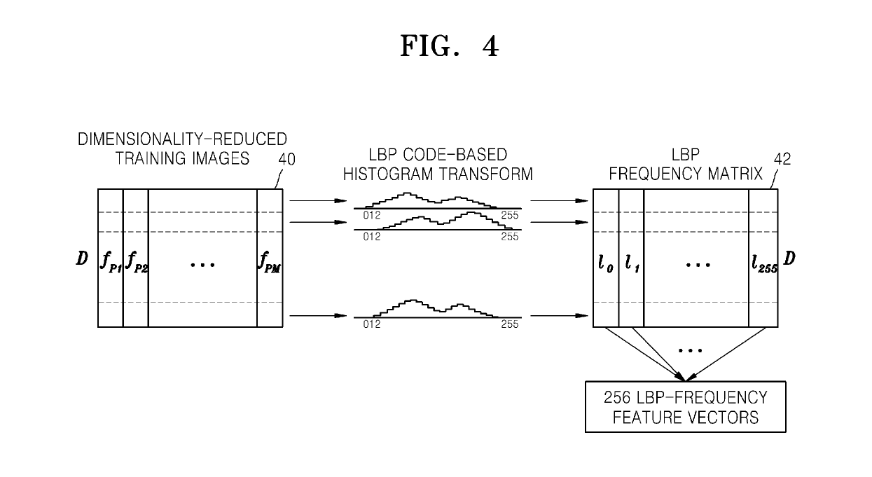

FIG. 4 is a diagram showing a process of performing an LBP code-based histogram transform per image for dimensionality-reduced training face images 40, each including M feature vectors f_{P1} to f_{PM}. LBP-based histogram vectors are obtained from the D dimensionality-reduced training face images 40. A D×256-dimensional LBP frequency matrix 42 is obtained from the D 256-dimensional histogram vectors. In the LBP frequency matrix 42, 256 column vectors I₀ to I₂₅₅ are LBP frequency feature vectors.

In operation 107 and 108, K frequency feature vectors maximizing mutual information between the 256 LBP frequency feature vectors and a class label are calculated by Equation 2.

$${argmax}_{{l}_{i} ∈ {F}_{CODE}} [ I ( C ; {l}_{i} ) - \frac{1}{\vert {S}_{CODE} \vert} {\sum }_{{l}_{j} ∈ {S}_{CODE}} I ( {l}_{i} ; {l}_{j} ) ] \qquad ( 2 )$$

Here, I(C;Iᵢ) denotes an amount of mutual information between a frequency feature vector and the class label vector, C denotes the class label vector, F_{CODE} denotes a set of the 256 LBP frequency feature vectors, Iᵢ denotes an i^{th} frequency feature vector, and S_{CODE} denotes a set of selected frequency feature vectors. Indices corresponding to elements of S_{CODE} are K finally obtained LBP codes.

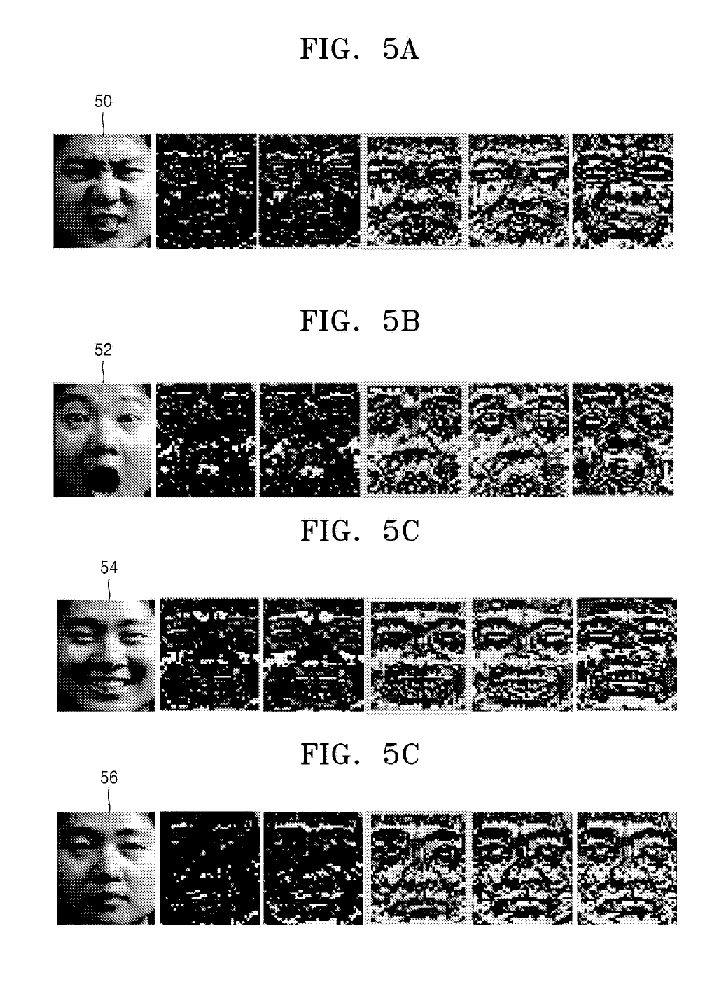

FIGS. 5A to 5D are images showing results sequentially representing 10, 20, 40, 60, and 80 selected LBP codes in a right direction for 4 face images 50, 52, 54, and 56.

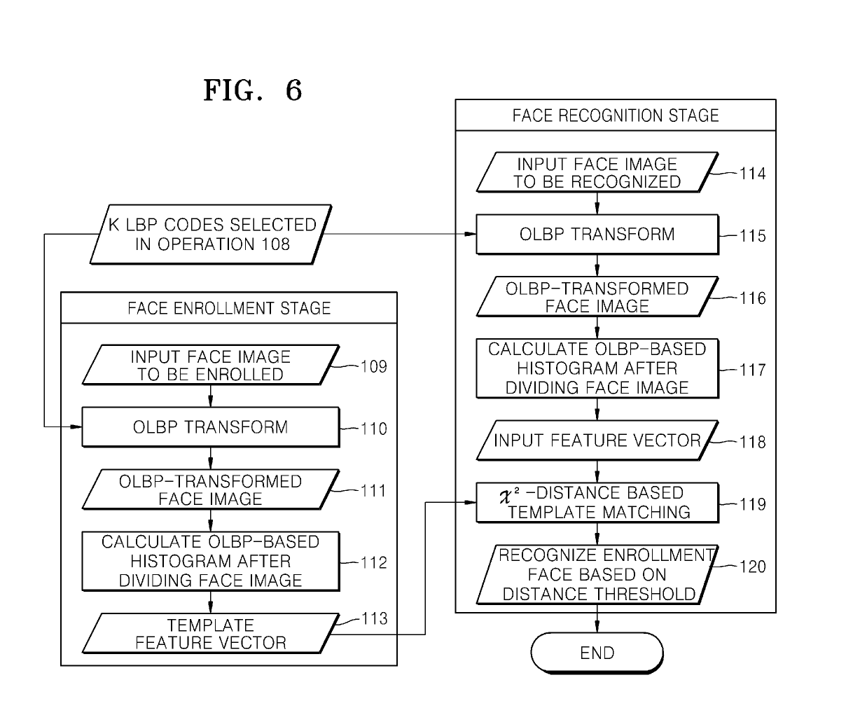

FIG. 6 is a flowchart of a method of applying K selected optimal LBP (OLBP) codes to a face recognition system, according to an exemplary embodiment of the present invention.

As shown in FIG. 1, K OLBP codes are selected through the face training stage including operations 100 to 108, and in FIG. 6, an example of applying the K OLBP codes selected according to an exemplary embodiment of the present invention for face recognition, which is a representative field of pattern recognition, is described. A conventional face recognition method is applied to face enrollment and recognition stages below.

In operation 109 to 111, a face is represented using K OLBP codes obtained for a single face image to be enrolled in the face enrollment stage. The transformed face image is divided into ra×rb regions so that a feature of each portion can be better recognized.

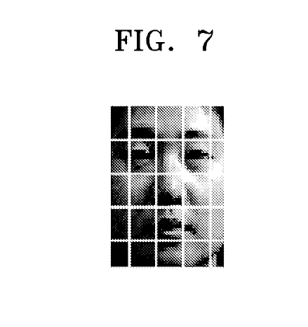

FIG. 7 shows an example of an enrollment face image divided into ra×rb, e.g., 5×5, regions. In operation 112, K OLBP-based histograms are calculated for each region of the enrollment face image divided into 5×5 regions. In operation 113, an ra×rb×K-dimensional template feature vector is obtained by sequentially concatenating histograms calculated independently for each of the ra×rb regions.

In operations 114 to 118, a face image is represented using the K OLBP codes for an input face image to be recognized in the face recognition stage. The transformed face image is divided into ra×rb regions. K OLBP-based histograms are calculated for each region of the divided input face image. An ra×rb×K-dimensional input feature vector is obtained by sequentially concatenating histograms calculated independently for each of the ra×rb regions. Since a more detailed stage description is the same as prior technology of a conventional face recognition method, it is omitted.

In operations 119 and 120, if a distance value between the template feature vector obtained in the face enrollment stage and the input feature vector obtained in the face recognition stage, which is calculated using a conventional X²-distance based matching method, is equal to or less than a predetermined threshold, it is determined that a person of the input face is an enrolled person. Otherwise, it is determined that the person of the input face is not an enrolled person. Also, if the number of face images enrolled in the face enrollment stage is T, distance values between T template feature vectors obtained in the face enrollment stage and the input feature vector obtained in the face recognition stage are calculated in the X²-distance based matching method for an input face image to be recognized in the face recognition stage, and recognition of the person of the input face with a plurality of enrolled persons is performed in the same method as the recognition method for a single enrolled person based on the predetermined threshold.

While this invention has been particularly shown and described with reference to preferred embodiments thereof, it will be understood by those of ordinary skill in the art that various modifications or changes in form and details may be made therein for expression recognition, gender recognition, etc. without departing from the spirit and scope of the invention as defined by the appended claims. Thus, future modifications of the embodiments of the invention will not depart from the technology of the invention.

What is claimed is:

1. A pattern recognition method using Maximization of Mutual Information (MMI)-based Local Binary Pattern (LBP) codes, the pattern recognition method comprising:
a) transforming D training face images into LBPs and generating dimensionality-reduced training face images with M feature vectors selected using a preset class label vector from among N feature vectors generated for each of the LBP-transformed training face images;
b) calculating 256 frequency feature vectors, each indicating a presence frequency of a corresponding LBP code, for each of the dimensionality-reduced training face images;
c) selecting K Optimal LBP (OLBP) codes maximizing mutual information with the class label vector for the 256 frequency feature vectors;
d) enrolling a face image by LBP-transforming the face image to be enrolled using the selected OLBP codes and generating a template feature vector; and
e) recognizing a face of an input face image by using the selected OLBP codes and the template feature vector calculated in the enrollment of the face image.

2. The pattern recognition method of claim 1, wherein, in operation a), the N feature vectors are N (the number w of horizontal pixels×the number h of vertical pixels) D-dimensional feature vectors based on positions of pixels of each of the LBP-transformed training face images.

3. The pattern recognition method of claim 1, wherein, in operation a), the M selected feature vectors are feature vectors maximizing mutual information with the preset class label vector among the N LBP-transformed feature vectors.

4. The pattern recognition method of claim 3, wherein the selection of the M feature vectors is computed by the following equation:
$${argmax}_{{f}_{i} ∈ {F}_{LBP}} [ I ( C ; {f}_{i} ) - \frac{1}{\vert {S}_{LBP} \vert} {\sum }_{{f}_{j} ∈ {S}_{LBP}} I ( {f}_{i} ; {f}_{j} ) ] ,$$
where I(C;fᵢ) denotes an amount of mutual information between a feature vector and the class label vector, C denotes the class label vector, F_{LBP} denotes a set of the N feature vectors, fᵢ denotes an i^{th} feature vector, and S_{LBP} denotes a set of selected feature vectors.

5. The pattern recognition method of claim 1, wherein, in operation b), the calculation of the 256 frequency feature vectors comprises:
b1) generating an LBP code-based histogram vector for each of the dimensionality-reduced training face images;
b2) generating 256 LBP frequency feature vectors, each indicating a presence frequency of a corresponding LBP vector, from the histogram vector; and
b3) selecting K frequency feature vectors maximizing mutual information with the preset class label vector among the 256 frequency feature vectors.

6. The pattern recognition method of claim 5, wherein, in operation b3), the selection of the K frequency feature vectors is computed by the following equation:
$${argmax}_{{l}_{i} ∈ {F}_{CODE}} [ I ( C ; {l}_{i} ) - \frac{1}{\vert {S}_{CODE} \vert} {\sum }_{{l}_{j} ∈ {S}_{CODE}} I ( {l}_{i} ; {l}_{j} ) ]$$
where I(C;Iᵢ) denotes an amount of mutual information between a frequency feature vector and the class label vector, C denotes the class label vector, F_{CODE} denotes a set of the 256 LBP frequency feature vectors, Iᵢ denotes an i^{th} frequency feature vector, and S_{CODE} denotes a set of selected frequency feature vectors.

7. The pattern recognition method of claim 1, wherein, in operation d), the generation of the template feature vector comprises:
d1) dividing the enrollment face image represented using the K LBP codes into ra×rb region units; and
d2) generating an ra×rb×K-dimensional template feature vector by calculating K OLBP-based histograms for each region in the divided enrollment face image and sequentially concatenating the histograms independently calculated for the ra×rb regions.

8. The pattern recognition method of claim 1, wherein operation e) comprises:
e1) dividing the input face image into ra×rb regions using the K OLBP codes;
e2) calculating an ra×rb×K-dimensional input feature vector by calculating K OLBP-based histograms for each region in the divided input face image and sequentially concatenating the histograms independently calculated for the ra×rb regions; and
e3) recognizing an input face based on a distance value between relative templates for each enrollment face image and the input face image by using the K OLBP codes.

9. A pattern recognition apparatus using Maximization of Mutual Information (MMI)-based Local Binary Pattern (LBP) codes, the pattern recognition apparatus comprising:
a means for transforming D training face images into LBPs and generating dimensionality-reduced training face images with M feature vectors selected using a preset class label vector from among N feature vectors generated for each of the LBP-transformed training face images;
a means for calculating 256 frequency feature vectors, each indicating a presence frequency of a corresponding LBP code, for each of the dimensionality-reduced training face images;
a means for selecting K Optimal LBP (OLBP) codes maximizing mutual information with the class label vector for the 256 frequency feature vectors;
a means for enrolling a face image by LBP-transforming the face image to be enrolled using the selected OLBP codes and generating a template feature vector; and
a means for recognizing a face of an input face image by using the selected OLBP codes and the template feature vector calculated in the enrollment of the face image.

10. A computer-readable recording medium storing a computer-readable program for executing the pattern recognition method using MMI-based LBP codes of claim 1.
